(19) United States
(12) Patent Application Publication
(10) Pub. No.: US 2004/0124730 A1
(43) Pub. Date: Jul. 1, 2004

(54) Wedge for stator core

(75) Inventors: Tsuyoshi Yamaguchi, Anjo-shi (JP); Shingo Hashimoto, Anjo-shi (JP); Tooru Kuroyanagi, Anjo-shi (JP)

Correspondence Address: OLIFF & BERRIDGE, PLC, P.O. BOX 19928, ALEXANDRIA, VA, 22320, US

(73) Assignee: AISIN AW CO., LTD., Anjo-shi (JP)

(21) Appl. No.: 10/736,671

(22) Filed: Dec. 17, 2003

(30) Foreign Application Priority Data
Dec. 19, 2002 (JP) 2002-368699

(51) Int. Cl. H02K 3/48

(52) U.S. Cl. 310/214

(57) ABSTRACT

A wedge having a high stiffness and a high fitting performance is provided. The wedge is fitted into a slot for inserting a coil formed at an inner circumferential side of a ring-shaped stator core such that the wedge closes an inner circumferential opening portion of the slot. The slot has a slot opening portion having a reduced gap at an inner circumferential end of the slot, and a general portion having an increased gap compared with the slot opening portion at an outer circumferential side of the slot. The wedge has a wider portion disposed in the general portion, and a convex portion having a smaller lateral size than that of the wider portion, which is arranged protrusively from the wider portion and disposed in the slot opening portion. The wedge is preferably formed by integrally molding the wider portion and the convex portion using synthetic resin.

This application is based on and incorporates herein by reference Japanese Patent Application No. 2002-368699 filed Dec. 19, 2002.

### BACKGROUND OF THE INVENTION

1. Field of Invention

The present invention relates to a wedge for a stator core.

2. Description of Related Art

In a stator core for use in a rotary electric machine, such as an electric motor, a coil formed by winding a wire is inserted into the slot in the core, and a wedge is fitted in an inner circumferential opening portion of the slot to prevent the wire (coil) from projecting from the slot.

FIG. 13 shows a conventional wedge 9 that is formed by folding an electrically insulative alamido-fiber sheet in a horseshoe pattern. Fitting of the wedge 9 into the slot 50 is typically performed when a coil 8 is inserted in an axial direction of a stator core 5.

The fitted wedge 9 is in contact with a projecting portion 551 of a tooth 55 formed in a slot opening portion 52. The slot opening portion 52 has a reduced lateral size at an inner circumferential end of a slot 50. The wedge 9 closes the inner circumferential opening portion of the slot 50. An example of such a horseshoe-pattern wedge, and a device for fitting the wedge into the slot, is disclosed in Japanese Patent JP-A-9-103053.

### SUMMARY OF THE INVENTION

When the coil 8 is inserted into the slot 50 of the stator core 5, it is useful to increase the size of the slot opening portion in order to aid in insertion of the coil. However, conventional sheet wedges are not able to prevent the coil from escaping.

Another problem with conventional sheet wedges is that such wedges are difficult to insert into a slot while forcing the coil aside when the coil is already inserted into the slot of the stator core. Therefore, known insertion methods are limited in their usefulness. These limitations are also due to a comparatively low stiffness of the sheet wedge.

The present invention provides a wedge having a high stiffness and a high fitting performance.

In an exemplary embodiment, the invention comprises a wedge for a stator core fitted in a slot in which a coil is arranged at an inner circumferential side of a ring-shape stator core such that the wedge closes an inner circumferential opening portion of the slot. The slot includes a slot opening portion having a reduced gap at an inner circumferential end of the slot and a general portion having an increased gap relative to the slot opening portion at an outer circumferential side of the slot. The wedge includes a wider portion and a convex portion having a smaller lateral size than that of the wider portion which is arranged protrusively from the wider portion. When the wedge is installed in the slot, the wider portion is disposed in the general portion of the slot and the convex portion is disposed in the slot opening portion.

The wedge of the exemplary embodiment has a shape having the wider portion and the convex portion. Therefore, wedge stiffness is remarkably high according to the shape compared with the conventional wedge made by folding the sheet material. Thus, even when the wedge is independently inserted after the coil has been inserted into the slot of the stator core, the wedge has sufficient stiffness to retain the coil in place. Furthermore, the lateral size of the slot opening portion can be increased compared with a conventional wedge by using the wedge of this invention due to its improved stiffness.

The wider portion and convex portion of the wedge are disposed in the general portion and slot opening portion of the slot in the stator core, respectively. Such a configuration provides a condition where the convex portion is engaged with the slot opening portion, which prevents the wedge from rotating and escaping from the slot opening portion. Accordingly, a condition where the inner circumferential opening portion of the slot is stably closed can be maintained. In this way, the invention can provide a wedge having a high stiffness and a high fitting performance.

### BRIEF DESCRIPTION OF THE DRAWINGS

FIG. 1 is a perspective view of a wedge according to a first exemplary embodiment of the invention;

FIG. 2 is an explanatory drawing showing a condition where the wedge is fitted into a slot in a stator core in the first embodiment;

FIG. 3 is an explanatory drawing showing a structure of an insertion device;

FIG. 4 is a cross sectional view along line A-A in the direction of the arrow in FIG. 3;

FIG. 5 is a cross sectional view along line B-B in the direction of the arrow in FIG. 3;

FIG. 6 is an explanatory drawing showing a starting condition where a wedge pusher in the insertion device begins processing;

FIG. 7 is an explanatory drawing showing a condition where the wedge pusher in the insertion device contacts with a blade unit;

FIG. 8 is an explanatory drawing showing a condition where the wedge is pushed from the insertion device into the slot in the stator core;

FIG. 9 is a perspective view of a wedge according to a second exemplary embodiment;

FIG. 10A is a perspective view of a wedge in the second embodiment;

FIG. 10B is a front view of the wedge in the second embodiment;

FIG. 10C is a bottom view of the wedge in the second embodiment;

FIG. 11 is a perspective view of a wedge in the second embodiment;

FIG. 12A is a perspective view of a wedge in the second embodiment;

FIG. 12B is a bottom view of the wedge in the second embodiment; and

FIG. 13 is an explanatory drawing showing a condition where the wedge is fitted into the slot in the stator core in the related art example.

### DETAILED DESCRIPTION OF PREFERRED EMBODIMENTS

First Embodiment

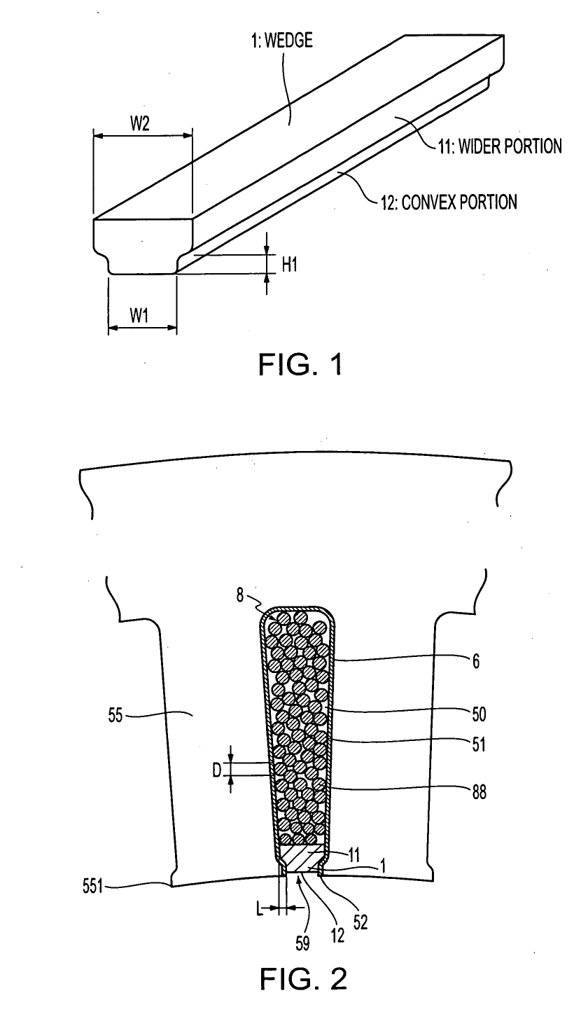

A wedge for a stator core according to an exemplary embodiment of the invention is described using FIG. 1 and FIG. 2.

In FIGS. 1 and 2, the wedge 1 is fitted into a slot 50 that houses a coil arranged at an inner circumferential side of a ring-shaped stator core 5 such that the wedge closes an inner circumferential opening portion 59 of the slot 50.

The slot 50 has a general portion 51 whose gap gently changes along a radial direction of the stator core 5, and a slot opening portion 52 having a drastically reduced gap at an inner circumferential end of the general portion 51.

The wedge 1 has a wider portion 11 disposed in the general portion 51 of the slot 50, and a convex portion 12 arranged protrusively from the wider portion 11 and disposed in the slot opening portion 52.

The stator core 5 in the embodiment has a ring-shape and a plurality of teeth 55 arranged in the inner circumferential portion of the stator core 5, among which the slot 50 is formed as shown in FIG. 2.

Each tooth 55, extends in a radial direction from an outer circumferential side to the inner circumferential side, and has a projecting portion 551 that projects circumferentially at an end of the tooth 55. A space to which the projecting portion 551 faces is the slot opening portion 52 of the slot 50, and a space formed between the teeth 55 forms the general portion 51.

In the embodiment as shown in the FIG. 2, an insulating film 6 made of electrically insulative synthetic resin is previously arranged on the whole of the inner circumferential surface of the slot 50. The film may be made of a Liquid Crystal Polymer (LCP). In the exemplary embodiment, the insulating film 6 is about 300 μm thick. The conventional electrically-insulative alamido-fiber sheet can be also used as the insulating film 6.

The wedge 1, as shown in FIG. 1, is integrally molded in an essentially T-shape having the wider portion 11 and the convex portion 12 using an LCP. The vertical size H1 of the convex portion 12 is slightly smaller than the radial size of the slot opening portion 52 or the thickness of the projecting portion 551. Lateral sizes W1, W2 of the convex portion 12 and the wider portion 11 are set to correspond with respective gaps of the slot opening portion 52 and general portion 51 of the slot 50, and designed to give a slight clearance (not shown) between the portions 11, 12 and the tooth 55 facing the portions 11, 12. In an exemplary embodiment, the wedge has an essentially T-shaped cross section.

The clearance is set to be sufficiently smaller than the size L (FIG. 2) of the inner wall surface forming the slot opening portion 52 of the stator core 5 projected from the inner wall surface forming the general portion, and sufficiently smaller than the diameter D (FIG. 2) of the electric wire forming the coil 8 to be inserted and disposed into the slot 50.

Although the slight clearance is arranged between the wedge 1 and the tooth 55 to improve the insertion performance, since the convex portion 12 also prevents the wedge 1 from rotating, it is preferable that the clearance is small as possible. It is most preferable that the wedge 1 is in tight surface-to-surface contact with the tooth 55 when fitted into slot 50.

In practice, the wedge 1 may be inserted into the slot 50 in the stator core 5 after a coil 8 has been inserted into the slot 50. In an exemplary embodiment, a radial insertion method may be used in which the coil 8 that has been previously formed by winding a wire 88, is inserted into the slot 50 by being moved almost straightly from the inner circumferential side of the stator core 5. Then, the wedge 1 is inserted into the inner circumferential opening portion of the slot 50 along an axial direction.

At that time, the convex portion 12 of the wedge 1 is located at the inner circumferential side of the stator core 5, and the wider portion 11 at the outer circumferential side, and respective portions are correspondingly inserted into the slot opening portion 52 and general portion 51 of the slot 50.

This method of insertion allows the inner circumferential opening portion of the slot 50 to be securely closed while the wider portion 11 and convex portion 12 of the wedge 1 are located in the general portion 51 and slot opening portion 52 of the slot 50, respectively.

The wedge 1 of the embodiment has a shape having the wider portion 11 and the convex portion 12 as described above. The stiffness of the wedge is remarkably high due to the shape compared with the conventional wedge that is made by folding the sheet material. Therefore, even in the case that the wedge 1 is independently inserted into the slot 50 after the coil 8 has been inserted into the slot 50 using the radial insertion method, the wedge remains in place. Furthermore, the lateral size of the slot opening portion 52 can be increased to a greater degree, compared with the conventional wedge, due to the improved stiffness of the wedge 1. Accordingly, the radial insertion method can be practiced more readily and the manufacturing process is more efficient.

The wider portion 11 and convex portion 12 of the wedge 1 are disposed in the general portion 51 and slot opening portion 52 of the slot 50 in the stator core 5, respectively. This arrangement allows the convex portion 12 to engage with the slot opening portion 52, which prevents the wedge 1 from rotating and escaping from the slot opening portion 52. Accordingly, a condition where the inner circumferential opening portion 59 of the slot 50 is stably closed can be maintained.

An example of an operation method for inserting the wedge 1 in the first embodiment into the slot 50 is described in further detail.

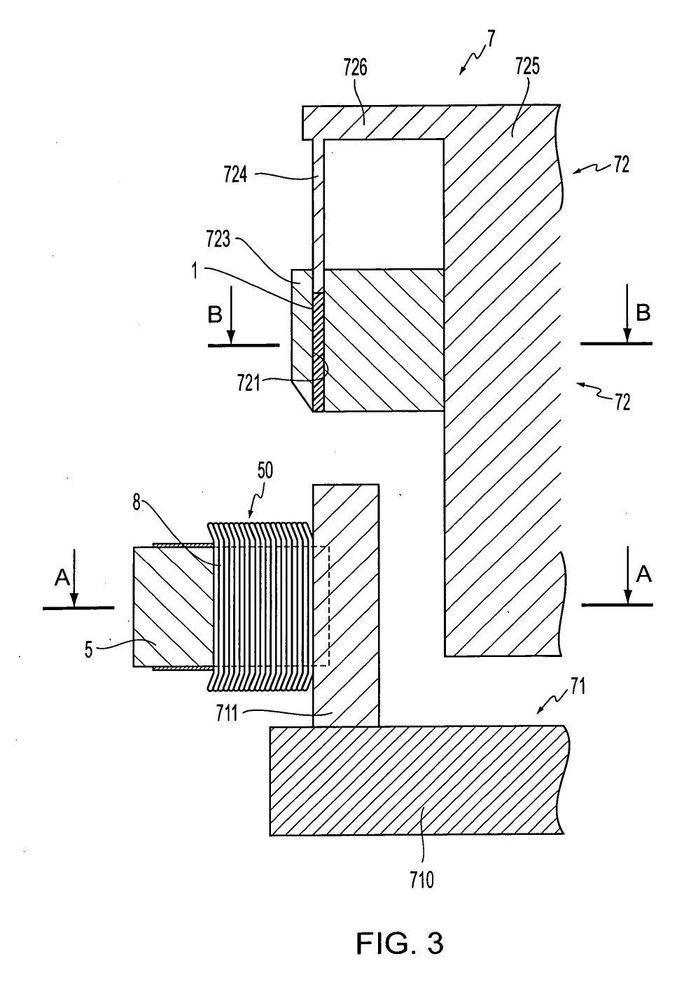

FIG. 3 shows, an insertion device 7 by which coil insertion and wedge insertion can be sequentially performed.

The insertion device 7 has a coil insertion portion 71 for performing the radial insertion method by straightly moving the coil 8 from the inner circumferential side of the stator core 5 to the outer circumferential side, and a wedge insertion portion 72 for moving the wedge 1 in an axial direction. Respective terms “axial direction” and “radial direction” in the following description mean an axial direction and a radial direction of a motor in the stator core 5 when the core 5 is disposed.

The coil insertion portion 71 has a blade unit 710 arranged movably in the radial direction and an insertion blade 711 arranged vertically from the blade unit 710 in the axial direction. The coil insertion portion 71 is arranged such that the portion 71 can move in the axial direction together with a wedge pusher 725, to be described later, when the portion 71 is contacted with the wedge pusher 725.

The wedge insertion portion 72 has a wedge magazine 723 having a disposition hole 721 for disposing the wedge 1 and the wedge pusher 725 having a press pin portion 724 for pressing the wedge 1. The press pin portion 724 is extendedly arranged in the axial direction from an arm portion 726 extending in the radial direction from the wedge pusher 725, and configured to move with the movement of the wedge pusher 725 in the axial direction.

The wedge pusher 725 and the wedge magazine 723 are arranged movably in the axial direction in synchronization with each other until the wedge magazine 723 contacts the stator core 5.

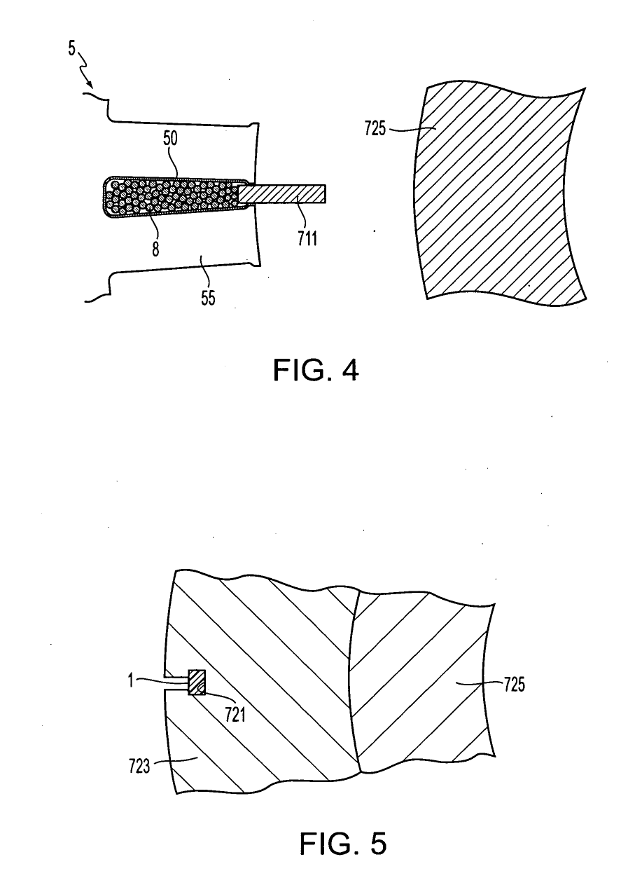

When the coil 8 is inserted into the slot 50 in the stator core 5, the insertion blade 711, which has been moved from the inner circumferential side to the outer circumferential side, is contacted with the coil 8 located at the inner circumferential side of the stator core 5, and further moved to more outer circumferential side. Thus, the coil 8 is straightly inserted and disposed into the slot 50 in the stator core 5, as shown in FIG. 3 and FIG. 4.

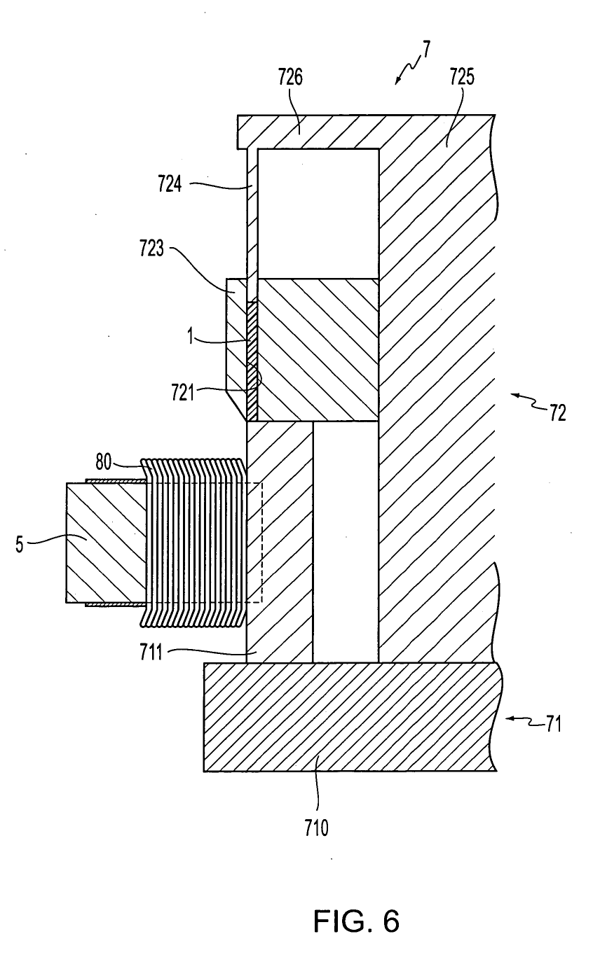

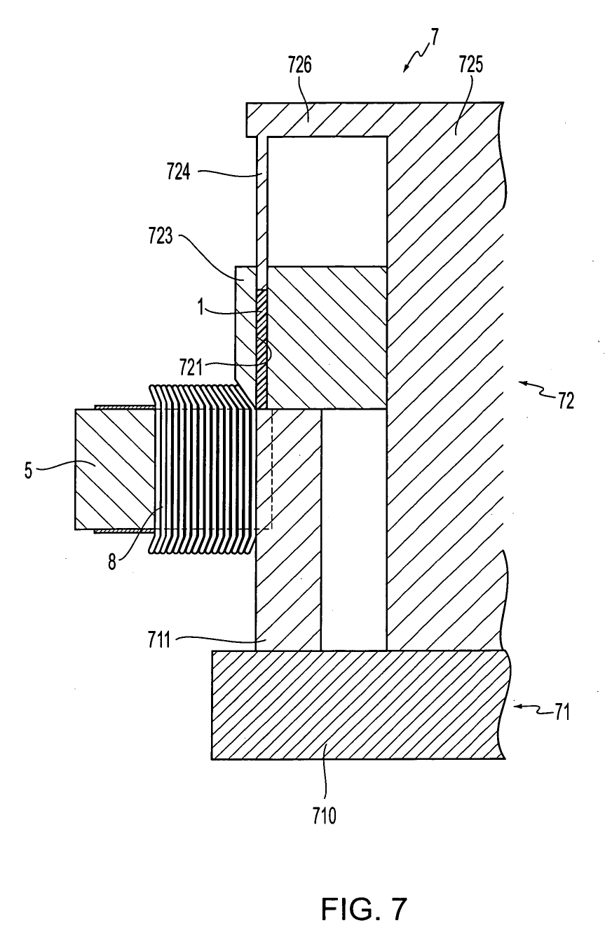

During insertion of the wedge 1, the wedge 1 is arranged in the disposition hole 721 in the wedge magazine 723, as shown in FIG. 3 and FIG. 5. Then, the wedge magazine 723 and the wedge pusher 725 are lowered in the axial direction in synchronization with each other. After a lower end of the wedge pusher 725 contacts the blade unit 710, as shown in FIG. 6, the wedge insertion portion 72 and the coil insertion portion 71 are moved downward in the axial direction in synchronization with each other, as shown in FIG. 7.

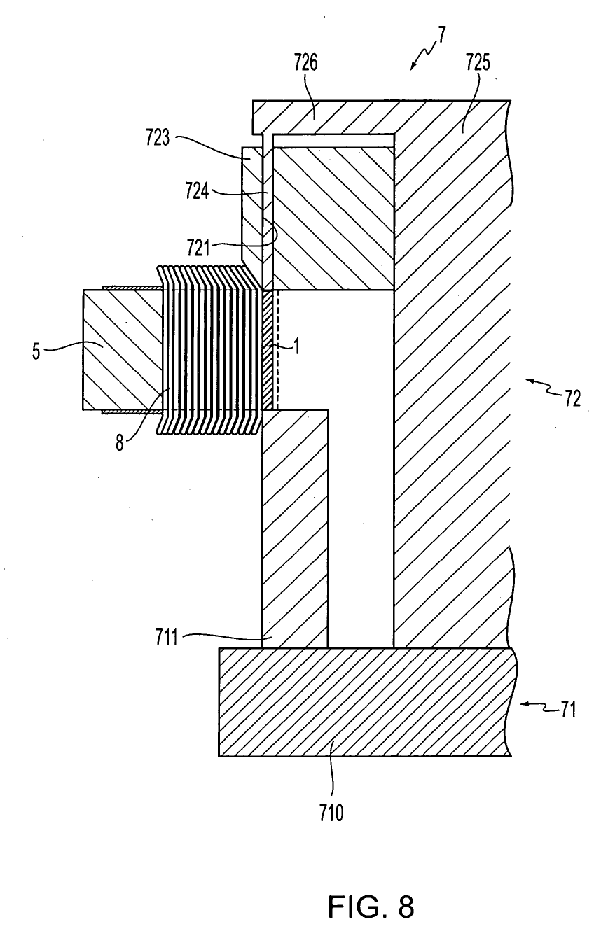

After the wedge magazine 723 contacts with the stator core 5, as shown in FIG. 8, only the wedge magazine 723 is stopped while other parts continue lowering. Thus, the press pin portion 724 of the wedge pusher 725 enters the disposition hole 721 in the wedge magazine 723 and downwardly forces out the wedge 1. Thus, the wedge 1 is inserted into the slot 50.

As described above, by using the insertion device 7, the wedge 1 can be securely inserted after the coil 8 has been inserted using the radial insertion method. Particularly, since the wedge 1 has a highly stiff shape having the wider portion 11 and the convex portion 12, the wedge 1 sufficiently withstands the pressure of the press pin portion 72, therefore a smooth insertion is achieved.

Second Embodiment

In this exemplary embodiment, the shape of the wedge 1 described in the first embodiment is modified.

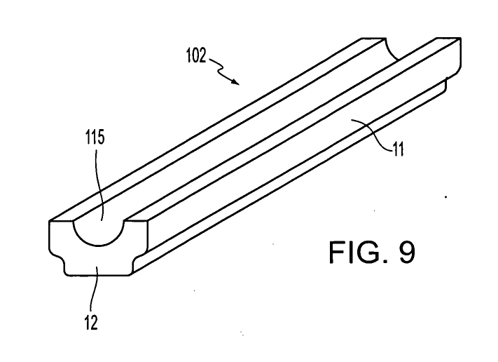

As shown in FIG. 9, wedge 102 has an inwardly depressed concave portion 115 formed on a surface of the wider portion 11 of the wedge 102. In this case, the amount of space within the slot 50 can be increased by the area of the concave portion 115, which improves the filling percentage of the coil. In an exemplary embodiment, the wedge has an essentially Y-shaped cross section.

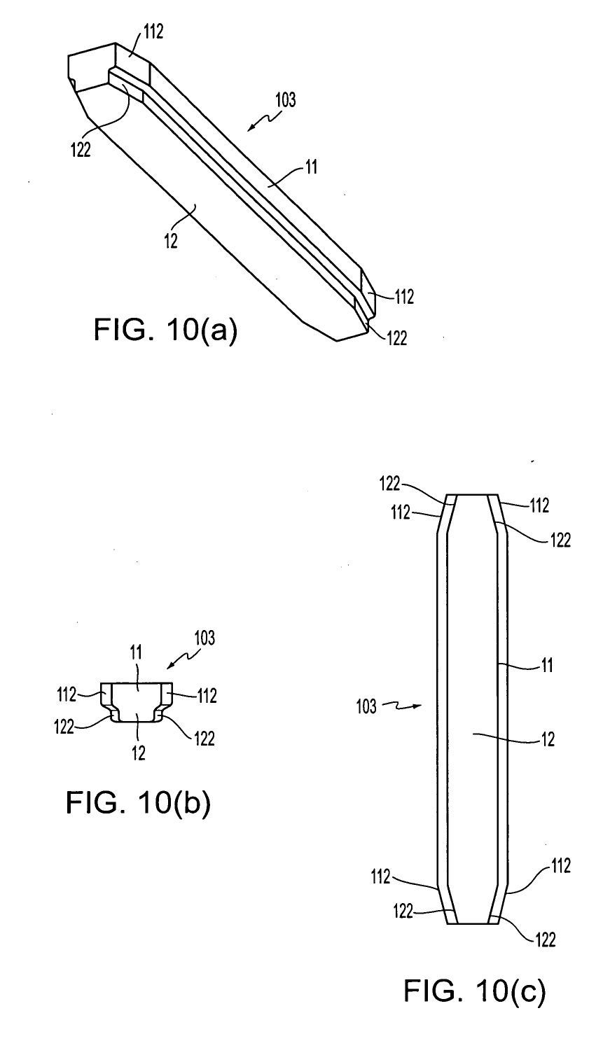

FIGS. 10a-c show an example of a wedge 103 having a tapered profile whose lateral size decreases toward an end of the wedge 103. The tapered profile is arranged at both of the wider portion 11 and the convex portion 12 in both longitudinal ends of the wedge 103. Specifically, as shown in the figures, tapered portions 112, 122 having the tapered profile on their sides are arranged on both ends of the wider portion 11 and the convex portion 12 respectively.

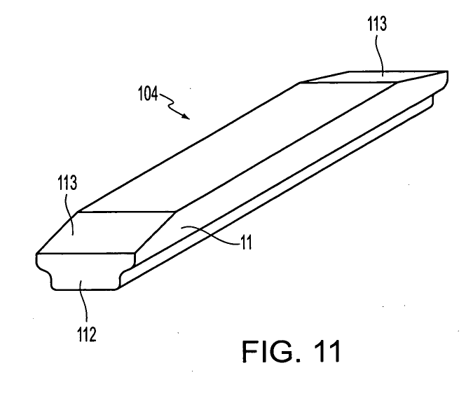

FIG. 11 shows an example of a wedge 104 having a tapered profile whose thickness decreases as an end of the wedge 104 is approached. The tapered profile is arranged at the convex portion 12 in both longitudinal ends of the wedge 104. Specifically, as shown in the figure, respective tapered portions 113 having the tapered profile were arranged on both end surfaces of the wider portion 11.

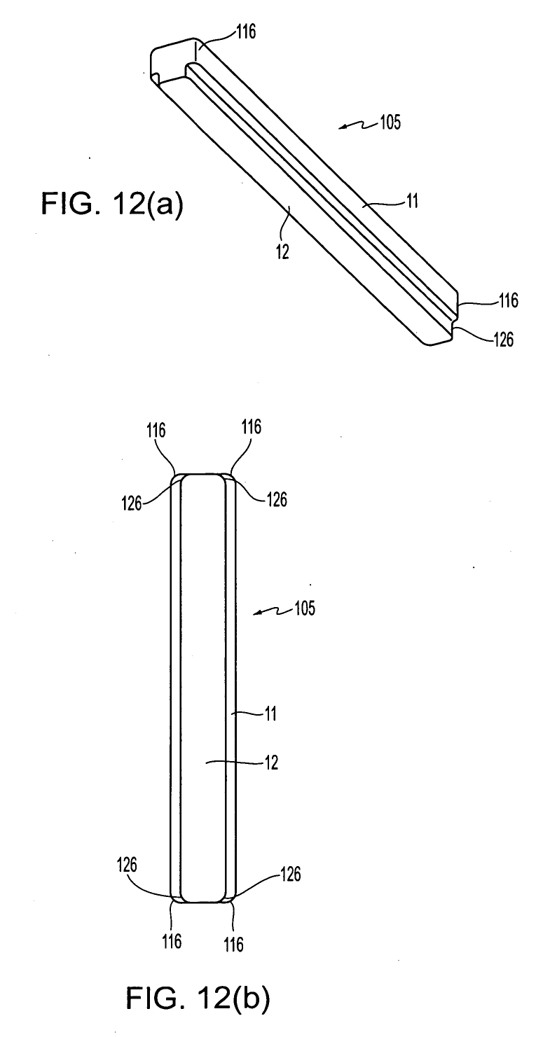

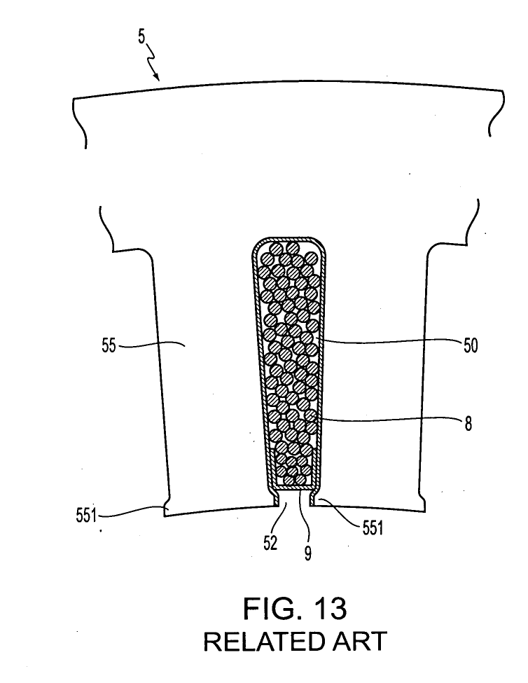

FIG. 12 shows an example of a wedge 105, in which both of the wider portion 11 and the convex portion 12 in both longitudinal ends of the wedge 105 have a rounded profile where end corners of the portions are finished in a curved pattern. More specifically, as shown in the figure, respective rounded portions 116, 126 having the rounded profile were arranged at all corners in both ends of the wider portion 11 and the convex portion 12.

In all of the wedges 103, 104, and 105, insertion performance can be further improved by the tapered profile or the rounded profile when the wedges are inserted into the slot 50. In addition, similar effects as the first embodiment can be obtained with the wedges 103, 104 and 105.

According to an exemplary embodiment of the invention, the wedge is preferably formed by integrally molding the wider portion and the convex portion using synthetic resin. In this case, the wedge can be easily produced and production cost can be reduced.

Various synthetic resins or plastics can be used as long as it has the properties required for the wedge, i.e., stiffness, electrically insulative properties, and some heat resistance. Among these, for example, a liquid crystal polymer (LCP) has high strength characteristics, and is particularly preferable.

In another aspect of the invention, the wedge includes an inwardly depressed concave portion formed on a surface of the wider portion of the wedge. In this way, the area within the slot can be increased by the amount of space provided by the concave portion thereby improving the filling percentage of the coil.

In a further aspect of the invention, at least one of the wider portion or the convex portion has a tapered profile at at least one longitudinal end of the wedge, whose lateral size or thickness decreases approaching the end of the wedge. In this way, when the wedge is inserted into the slot, even if a coil has already been inserted, the wedge can be inserted by pushing the coil aside along the tapered profile, resulting in improvement of insertion performance of the wedge.

In a further aspect of the invention, at least one of the wider portion or the convex portion, at least one longitudinal end of the wedge, is configured to have a rounded profile where an end corner of the portion is finished in a curved pattern. In this way, insertion performance can be improved by the rounded profile when the wedge is inserted into the slot.

In yet a further aspect of the invention, the wider portion of the wedge preferably has such a lateral size that the wider portion is disposed to maintain a predetermined clearance between the wider portion and an inner wall surface of the general portion of the slot. In this case, when the wedge is inserted into the slot in the stator core, the wedge does not encounter frictional resistance of the inner wall surface of the general portion of the slot, thereby further improving insertion performance of the wedge.

In still another aspect of the invention, the clearance is preferably smaller than a space between an inner wall surface forming the slot opening portion projected from the inner wall surface forming the general portion. This configuration prevents the wider portion of the wedge from passing through the slot opening portion and escaping. Therefore, the wedge is prevented from escaping in an axial direction due to friction between the wedge and the portion projected from the inner wall surface when the wedge is disposed in the slot.

In a further aspect of the invention, the clearance is preferably smaller than a diameter of an electrical wire forming the coil to be inserted into the slot. In this way, the electric wire for the coil in the slot is prevented from entering a slot opening side beyond the wedge, thereby inhibiting creeping current.

What is claimed is:

1. A wedge for a stator core fitted into a slot for inserting a coil, the slot having a slot opening portion and a general portion, the wedge comprising:
a substantially rigid, elongated body;
a wider portion disposed along a length of the body; and
a convex portion disposed opposite the wider portion, the convex portion having a smaller lateral size than that of the wider portion, wherein the convex portion is arranged protrusively from the wider portion

2. The wedge according to claim 1, wherein the wedge is formed by integrally molding the wider portion and the convex portion using synthetic resin.

3. The wedge according to claim 2, further comprising an inwardly depressed concave portion on a surface opposite to a surface on which the convex portion is formed of the wider portion of the wedge.

4. The wedge according to claim 3, wherein at least one of the wider portion and the convex portion has a tapered profile at at least one longitudinal end of the wedge whose lateral size or thickness decreases as the taper approaches the at least one longitudinal end.

5. The wedge according to claim 3, wherein at least one of the wider portion and the convex portion has a rounded profile at at least one longitudinal end of the wedge and an end corner of the rounded portion is finished in a curved pattern.

6. The wedge according to claim 2, wherein at least one of the wider portion and the convex portion has a tapered profile at at least one longitudinal end of the wedge whose lateral size or thickness decreases as the taper approaches the at least one longitudinal end.

7. The wedge according to claim 2, wherein at least one of the wider portion and the convex portion has a rounded profile at at least one longitudinal end of the wedge where an end corner of the rounded portion is finished in a curved pattern.

8. The wedge according to claim 1, wherein an inwardly depressed concave portion is formed on a surface opposite to a surface on which the convex portion is formed of the wider portion of the wedge.

9. The wedge according to claim 8, wherein at least one of the wider portion and the convex portion has a rounded profile at at least one longitudinal end of the wedge and an end corner of the at least one of the wider portion and the convex portion is finished in a curved pattern.

10. The wedge according to claim 1, wherein at least one of the wider portion and the convex portion has a tapered profile at at least one longitudinal end of the wedge whose lateral size or thickness decreases as the taper approaches the at least one longitudinal end.

11. The wedge according to claim 1, wherein at least one of the wider portion and the convex portion has a rounded profile at at least one longitudinal end of the wedge and an end corner of the at least one of the wider portion and the convex portion is finished in a curved pattern.

12. The wedge according to claim 1, wherein a lateral dimension of the wider portion is smaller than a lateral dimension of the slot in the stator core to form a predetermined clearance between the wider portion and an inner wall surface of the general slot.

13. The wedge according to claim 12, wherein the clearance is smaller than a size of an inner wall surface forming the slot opening portion in the stator core projected from an inner wall surface forming the general portion.

14. The wedge according to claim 13, wherein the clearance is smaller than a diameter of an electrical wire forming a coil to be inserted into the slot.

15. The wedge according to claim 12, wherein the clearance is smaller than a diameter of an electrical wire forming a coil to be inserted into the slot in the stator core.

16. The wedge according to claim 1, wherein a cross-section of the wedge has an essentially T-shape.

17. The wedge according to claim 3, wherein a cross-section of the wedge has an essentially Y-shape.

18. A wedge for a stator core fitted into a slot for inserting a coil arranged at an inner circumferential side of a ring-shape stator core such that the wedge closes an inner circumferential opening portion of the slot,
the slot having a slot opening portion having a reduced gap at an inner circumferential end of the slot, and a general portion having an increased gap compared with the slot opening portion at an outer circumferential side,
the wedge having a wider portion disposed in the general portion and a convex portion having a smaller lateral size than that of the wider portion, which is arranged protrusively from the wider portion and disposed in the slot opening portion.
